(19) United States
(12) Patent Application Publication
(10) Pub. No.: US 2006/0279710 A1
(43) Pub. Date: Dec. 14, 2006

(54) Image projection apparatus

(75) Inventor: Naoaki Tani, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 11/448,951

(22) Filed: Jun. 7, 2006

(30) Foreign Application Priority Data
Jun. 13, 2005 (JP) 2005-172156

(51) Int. Cl. G03B 21/20

(52) U.S. Cl. 353/85

(57) ABSTRACT

There is provided An image projection apparatus comprising: a spatial light modulation element that modulates illumination light by switching the display and non-display statuses of the respective pixels based on pulse width modulation driving to perform gradation expression for each pixel; a light source section able to increase and decrease the amount of illumination light output according to an input controlled variable; a light source control section that periodically controls the light amount of the illumination light output from the light source section; and a projection optical section that projects images modulated by the spatial light modulation element, wherein the light source control section selectively controls the light amount of the illumination light output from the light source section by either one of a first mode in which the controlled variable is changed in a first control period that is shorter than the display period for the spatial light modulation element to display the input image information, and a second mode in which the controlled variable is changed in a second control period that is longer than the first control period.

### BACKGROUND OF THE INVENTION

1. Field of the Invention

The present invention relates to an image projection apparatus that displays an image of multiple gradations by pulse-width modulating (PWM) light illuminated on an image modulation device for each pixel, and in particular, to one that maintains a required light amount while improving color characteristics of the image.

This application is based on Japanese Patent Application No. 2005-172156, the content of which is incorporated herein by reference.

2. Description of Related Art

In recent years, light emitting diodes (hereinafter referred to as “LEDs”), which are one type of semiconductor light source, have drawn attention as an alternative light source to light bulbs. The advantages of LEDs such as small size, greater durability, longer operating life, and lower power consumption have received much attention, and LEDs have been used as an alternative to lamps for indicators and the like. However, as there has been a notable improvement in luminous efficiency and luminous output in recent years, greater use of LEDs as an alternative light source to light bulbs is expected. In particular, as the light source of a small size projector, use of LEDs having an improved heat radiation efficiency of the package, allowing the application of high current, and increasing an absolute light amount by using a large size chip, has been considered.

On the other hand, in many small projectors, a spatial light modulation element such as a digital micromirror device (DMD) is used to modulate illumination light by rapidly switching minute mirrors of respective pixels arranged in a matrix, to angles of ON and OFF states by PWM driving in accordance with image data. Since such a spatial light modulation element differs from a conventional liquid crystal display element (LCD) and enables high speed operation, images of R (red), G (green), and B (blue) can be displayed in a field sequential mode. Also, displaying a color image has conventionally required three LCDs, however, one DMD element can realize a color projector. Moreover, since there is not the polarization dependency seen in an LCD, it is easy to configure an optical system that has a low loss with respect to a light source that generates non-polarized light from the LED.

For example, a projector having a combination of an LED light source and a DMD is disclosed in “26.1: RGB LED Illuminator for Pocket-Sized Projectors”, Matthijs H. Keuper, Gerard Harbers, Steve Paolini, SID 04 DIGEST, page 943 to 945. This is a projector that projects a color image by applying constant pulse current that has a duration of a display period of each color to the respective RGB LEDs, according to an RGB field sequential display, to thereby irradiate RGB illumination light onto the DMD. Furthermore, for example, in Japanese Patent No. 3564454, a projector that is configured with a light source using a lamp and color wheel is disclosed.

However, the light emission amount of an LED changes depending on the temperature of the light emitting element, and the light emission amount rapidly drops as temperature rises. In practice, even if constant pulse current is respectively applied to LEDs of the respective colors in display periods of each RGB color, although in the beginning of pulse lighting the temperature of the light emitting element is low and the light emission amount is large, as the temperature of the light emitting element rises due to heat generation, the light emission amount at the end of pulse lighting drops markedly.

FIG. 19 shows the waveforms of respective sections of a conventional projector that uses LEDs as a light emission source, and a DMD element as a spatial light modulation element. As shown in FIG. 19, one frame is divided into modulation display periods of red, green, and blue. As shown in A to C of FIG. 19, a driving current is supplied for driving the red, green, and blue LEDs in the modulation display periods of red, green, and blue. By means of this driving current, the red, green, and blue LEDs emit light as shown in D to F of FIG. 19. A PWM modulated DMD driving pulse is supplied to the DMD element as shown in G of FIG. 19. As a result, projection light amounts shown in H to J of FIG. 19 can be obtained in the red, green, and blue modulation display periods.

Even with a constant LED driving current as shown in A to C of FIG. 19, since the temperature of the LED rises due to its heat generation, the light amounts of the LEDs of each color drop over time as shown in D to F of FIG. 19. Therefore, the projection light amount changes over time as shown in H to J of FIG. 19.

As mentioned above, the DMD gives gradations (light amount level) to illumination light with respect to each pixel based on PWM driving. That is to say, in the case where 8 bit gradation from 0 to 255 is given for example, the modulation display period is divided into eight types of pulses in which the total time duration is equal to the modulation display period, and the time ratio is 1:2:4 8:16:32:64:128, and the illumination light is reflected in the direction of the projection optical section by the minute mirrors only during the period where the pulse is ON with a combination of these pulses. As a result, in each modulation display period, a correct gradation can be displayed as long as the light amount of the illumination light is constant. However, when the light amount of the illumination light changes, the correct gradation cannot be displayed.

As disclosed in Japanese Patent No. 3564454, since the light amount of the illumination light to the DMD is constant in a projector that generates illumination light corresponding to an RGB field sequence using the combination of a color wheel and a white light source such as a continuously lit ultra-high pressure mercury lamp, there is no problem in displaying gradation.

However, in the case of using an LED as a light source, if the LED is driven by a constant pulse current, a problem occurs in that the light amount of the illumination light varies, and the gradation cannot be displayed correctly by the DMD.

Accordingly, since the average light emission amount of an LED can be maximized when the LED is driven by a constant pulse current, this is effective in that the LED projector, which has considerably less light amount than a conventional lamp projector, can be used more brightly However, since gradation expression cannot be correctly performed, color shift occurs in half tone gradation, and hence excellence in color, which is another advantage of having LEDs as a light source, is impaired.

### BRIEF SUMMARY OF THE INVENTION

In consideration of the heretofore known problems described above, an object of the present invention is to provide an image projection apparatus that allows a selection of one of two modes: a mode that prioritizes brightness; and a mode for obtaining the color excellence of an LED, while ensuring a sufficient light amount, and preventing deterioration in color characteristics due to light amount variation.

The present invention provides an image projection apparatus that displays images according to image information that is input, and has a plurality of pixels that can be independently switched between display status and non display status, arrayed in a matrix, comprising: a spatial light modulation element that modulates illumination light by switching the display and non-display statuses of the respective pixels based on pulse width modulation driving to perform gradation expression for each pixel; a light source section able to increase and decrease the amount of illumination light output according to an input controlled variable; a light source control section that periodically controls the light amount of the illumination light output from the light source section; and a projection optical section that projects images modulated by the spatial light modulation element, wherein the light source control section-selectively performs control by either one of a first mode in which the controlled variable is changed in a first control period that is shorter than the display period for the spatial light modulation element to display the input image information, and a second mode in which the controlled variable is changed in a second control period that is longer than the first control period.

In the above image projection apparatus, the second control period in the second mode may be equal to or longer than the display period.

In the above image projection apparatus, the first control period in the first mode may be equal to or longer than a minimum duration to put pixels into display status when performing gradation expression using pulse width modulation driving.

In the above image projection apparatus, the light source control section may control the light amount of the illumination light output of the light source section so that a time average value of the illumination light is greater in the second mode than in the first mode.

The above image projection apparatus may have a control information storage section that stores light amount control information, and may control the light amount of the illumination light output of the light source section based on control information from the control information storage section, in at least the first mode.

The above image projection apparatus may further have a light amount detection section that detects the light amount of the illumination light output of the light source section, and may change the control information stored in the control information storage section based on a detection result of this light amount detection section.

The above image projection apparatus may perform a series of operations within the first control period in the first mode, the series of operations comprising: obtaining control information from the control information storage section, controlling the light amount of the illumination light output of the light source section based on the control information, obtaining the output of the light amount detection section, changing the control information from the control information storage section based on this output, and storing the changed control information in the control information storage section again.

The above image projection apparatus may perform a series of operations within the second control period in the second mode, the series of operations comprising: obtaining control information from the control information storage section, controlling the light amount of the illumination light output of the light source section based on the control information, obtaining the output of the light amount detection section, changing the control information from the control information storage section based on this output, and storing the changed control information in the control information storage section again.

The above image projection apparatus may have a variable section for a user to change the first control period and/or the second control period.

In the above image projection apparatus, the light source control section may change the first control period and/or the second control period according to the type of the image information.

The image projection apparatus, may be configured to allow a user to make a selection between the first mode and the second mode.

In the above image projection apparatus, the light source section may comprise: a plurality of light emitting elements arranged in a circle; and a rotation optical section that selectively guides light output from the plurality of the light emitting elements to a common light path by rotating around a rotation axis passing through the center of the circle, and the common light path may be provided coaxially with the rotation axis, and the light amount detection section may be disposed on an axis that extends along a light path in common with the rotation axis.

The above image projection apparatus may further have a reflecting surface that reflects the light outputted from the rotation optical section, and the reflection characteristic of a minute area centered around the rotation axis of the reflecting surface may be made different from that of the circumference, and light that passes through this minute area becomes light that is received by the light amount detection section.

In the above image projection apparatus, the reflecting surface may be an internal surface of a prism disposed on an optically back side of the rotation optical section, and the minute area may be formed by having a minute optical element adhered to an outside of the reflecting surface, and light that passes through this minute area becomes light that is received by the light amount detection section.

The present invention is suitable for preventing deterioration in color characteristics while ensuring a sufficient light amount in a projector that employs a DMD for a spatial light modulation element, and LEDs for a light source.

According to the present invention, either one of the first mode, in which the controlled variable is changed in a first control period that is shorter than the display period for the spatial light modulation element to display the input image information, and the second mode, in which the controlled variable is changed in a second control period that is longer than the first control period, can be set. Since the light amount becomes constant within a modulation display period of each color when set to the first mode, the relationship between an input signal level and the light amount at respective signal levels becomes linear. As a result, gradation expression is correctly performed and excellent color characteristics can be obtained. When set to the second mode, the driving current becomes constant. In the second mode, there is a possibility of deterioration in gradation characteristics due to light amount variation. However, the second mode produces a brighter picture compared to the first mode. Accordingly, by enabling setting of the first mode for color priority and the second mode for light amount priority, deterioration in color characteristics caused by light amount variation can be prevented while ensuring a sufficient light amount.

### BRIEF DESCRIPTION OF THE SEVERAL VIEWS OF THE DRAWINGS

FIG. 1 is a block diagram of a first embodiment of the present invention.

FIG. 2 is a timing diagram for describing the first embodiment of the present invention.

FIG. 3 is a block diagram showing a configuration of an LED drive control circuit in the first embodiment of the present invention.

FIG. 4 is a flow chart showing the operation in a light amount priority mode in the first embodiment of the present invention.

FIG. 5 is a flow chart showing the operation in a color priority mode in the first embodiment of the present invention.

FIG. 6A is a flow chart showing operation timing in the light amount priority mode in the first embodiment of the present invention.

FIG. 6B is a flow chart showing operation timing in the color priority mode in the first embodiment of the present invention.

FIG. 7 is a waveform diagram for describing the light amount priority mode in the first embodiment of the present invention.

FIG. 8 is a waveform diagram for describing the color priority mode in the first embodiment of the present invention.

FIG. 9 is a graph that shows gradation characteristics of modulated light in the color priority mode and the light amount priority mode in the first embodiment of the present invention.

FIG. 10 is a block diagram of a second embodiment of the present invention.

FIG. 11 is an explanatory diagram of an LED arrangement in the second embodiment of the present invention.

FIG. 12 is a block diagram showing a configuration of a light source drive control circuit in the second embodiment of the present invention.

FIG. 13 is a waveform diagram for describing a light amount priority mode in the second embodiment of the present invention.

FIG. 14 is a waveform diagram for describing a color priority mode in the second embodiment of the present invention.

FIG. 15 is a graph that shows gradation characteristics of modulated light in the color priority mode and the light amount priority mode in the second embodiment of the present invention.

FIG. 16A and FIG. 16B are explanatory diagrams of light irradiation angle distribution due to rotation of a rod.

FIG. 17 is an explanatory diagram of changes in monitor light amount due to rotation of the rod.

FIG. 18 is a perspective view showing a configuration of a monitor light collection section in the second embodiment of the present invention.

FIG. 19 is a waveform diagram for describing relationships between an LED driving current, an LED light amount, and a projection light.

### DETAILED DESCRIPTION OF THE INVENTION

Hereinafter, embodiments of the present invention are described, with reference to the drawings.

### First Embodiment

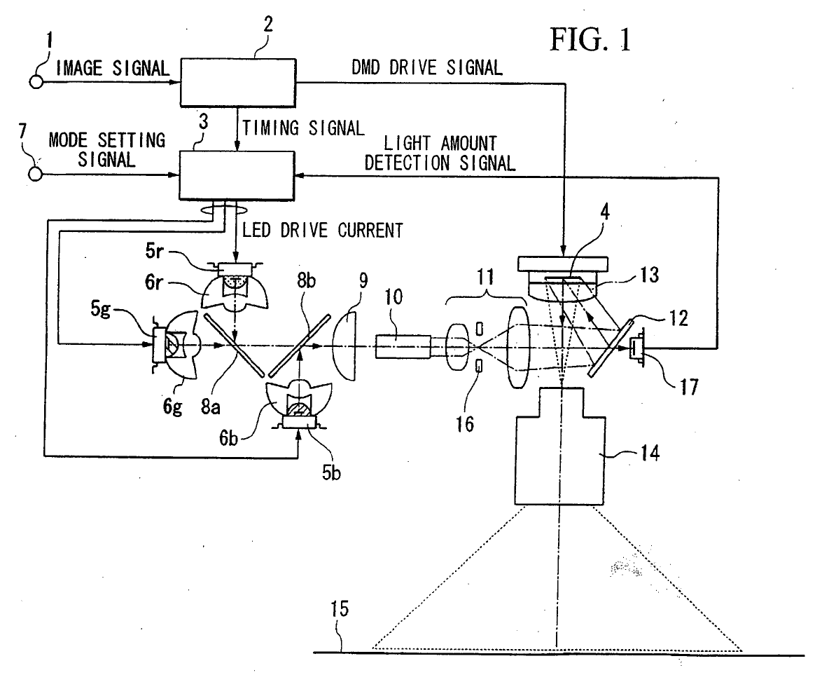

FIG. 1 shows a first embodiment of a projector to which the present invention is applied. In FIG. 1, an image signal is supplied to an input terminal 1. The image signal from the input terminal 1 is supplied to a DMD drive control circuit 2. The DMD drive control circuit 2 converts the input image signal into an RGB field sequential DMD driving signal, and outputs this field sequential DMD driving signal to a DMD element 4.

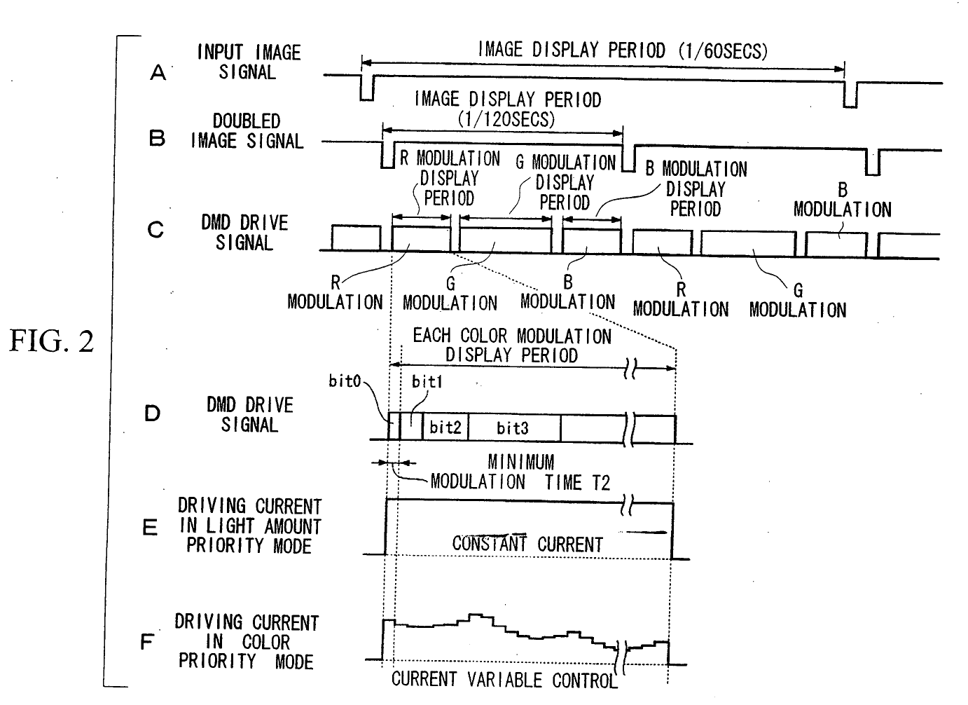

That is to say, as shown in A of FIG. 2, one period T0 of the input image signal is, for example, 1/60 seconds in the case of NTSC format. This input image signal is doubled as shown in B of FIG. 2 in order to prevent color breakup. One period T1 of a doubled DMD driving signal is, for example, 1/120 seconds, and this becomes an image display period. Within the image display period T1 of each DMD driving signal, the R modulation display period, B modulation display period, and G modulation display period are set as shown in C of FIG. 2. As shown in D of FIG. 2, within the modulation display period of each color, a PWM modulated DMD driving signal is supplied.

Moreover, in FIG. 1, a timing signal that synchronizes with the field sequential driving signal is generated in the DMD drive control circuit 2. This timing signal is supplied to an LED drive control circuit 3.

The DMD element 4 is a spatial light modulation element that has a large number of minute mirrors disposed on the surface thereof, the angles of the mirrors being changeable with respect to each pixel. When the DMD driving signal from the DMD drive control circuit 2 is given to the DMD element 4, the angles of the minute mirrors on the surface of the DMD element 4 change with respect to each pixel, consequently changing the path of the light to perform ON/OFF of the light for each pixel.

The LED drive control circuit 3 generates a driving current for each of the RGB LEDS based on the timing signal from the DMD drive control circuit 2, according to the R modulation display period, the G modulation display period, and the B modulation display period. Moreover, a mode setting signal from the input terminal 7 is supplied to the LED drive control circuit 3. The mode setting signal is a signal for switching between the light amount priority mode and the color priority mode.

The LED drive control circuit 3 generates a constant driving current in the light amount priority mode as shown in E of FIG. 2. On the other hand, in the color priority mode, as shown in F of FIG. 2, the LED driving current is varied within the modulation display period of each color for every minimum modulation time T2, in order to make the light amount constant.

Here a case where the driving current is constant in the light amount priority mode has been described. However, the LED driving current may be varied by feedback control in some cases as described later. In this case, the LED driving current is varied in a period equal to or greater than the image display period T1. On the other hand, in color priority mode, the LED driving current is varied for every minimum modulation time T2. Therefore, in their relationship with respect to the control period of the LED driving current, the control period in the color priority mode is shorter than the control period in the light amount priority mode.

In FIG. 1, the LED driving current set in the LED drive control circuit 3 is applied to LEDs 5r, 5g, and 5b. As a result, the LEDs 5r, 5g, and 5b light according to each of the RGB modulation display periods.

The light of the respective colors from the LEDs 5r, 5g, and 5b is reflected and refracted by collimators 6r, 6g, and 6b and converted into light of a higher parallelism. It is then synthesized into a common light path by two dichroic mirrors 8a and 8b. Then it is converged again by a converging lens 9, and outputted by a rod integrator 10. The rod integrator 10 removes unevenness in the light amount in the sectional direction. The light outputted from the output end of the rod integrator 10 travels through an illumination optical system comprising an illumination lens 11, an illumination aperture 16, a mirror 12, and a field lens 13, and is then irradiated onto the surface of the DMD element 4 on which the minute mirrors are formed. By designing the illumination optical system to allow the image of the output end of the rod integrator 10 to be substantially formed on the DMD element 4, an illumination having low unevenness can be realized.

The angles of the minute mirrors on the surface of the DMD element 4 are changed by the DMD driving signal, thereby changing the path of the light. Therefore, the reflected light of the DMD element 4 is modulated for each pixel by the DMD driving signal. The light modulated by this DMD driving signal is magnified through a projection lens 14, and is projected onto a projection surface 15 as projection light. As a result, an image made up of a plurality of pixels which are two dimensionally arranged in a matrix, is projected onto the projection surface 15.

A reflective film is provided on the mirror 12 in the illumination optical system in such a way that while a significant portion of the light is reflected to the DMD element 4 side, a small portion of the light passes through. A light amount sensor 17 is disposed on the back surface of this mirror 12. The light taken from each of the LEDs 5r, 5g, and 5b of RGB colors at a constant ratio can be detected within their respective light emitting periods by this light amount sensor 17. A light amount detection signal from this light amount sensor 17 is supplied to the LED drive control circuit 3.

If the entire surface of the mirror 12 allows some portion of the light to pass through, some ineffective light that does not enter the light amount sensor 17 will be generated. Therefore, in order to obtain a bright image, it is preferable to guide the light only to the light amount sensor 17 by providing a pinhole on a portion of the reflective film on the mirror surface of the mirror 12.

Accordingly, in the embodiment of the present invention, the light amount priority mode and the color priority mode can be set according to the mode setting signal from the input terminal 7. When the light amount priority mode is set, the driving current of the respective RGB LEDs 5r, 5g, 5b is constant. Conversely, in the color priority mode, the driving current of the respective RGB LEDs 5r, 5g, 5B is varied to make the light amount constant. In the light amount priority mode, a large amount of light amount can be obtained, but there may be a case in which the color gradation cannot be maintained. On the other hand, in the color priority mode, color gradation is correctly expressed, but the light amount is less compared to the light amount priority mode.

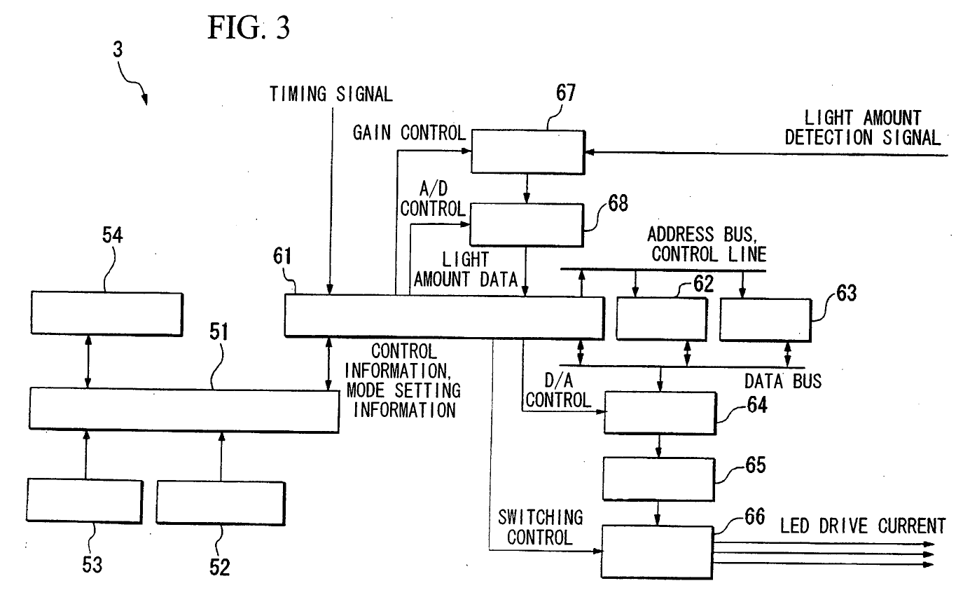

FIG. 3 shows a specific configuration example of the LED drive control circuit 3. In FIG. 3, a projector control section 51 is configured mainly with a CPU (Central Processing Unit) that controls the overall projector. The projector control section 51 is connected to a light source control section 61.

The projector control section 51 receives signals from an input signal discriminator 52 that discriminates the type and presence of the input image, and from a user I/F section 53 such as an operation panel or remote controller for a user to perform various kinds of settings, and outputs control information and mode setting information to the light source control section 61. The light amount priority mode and the color priority mode can be set by a user setting as well as by image source type and environment of use. For example, if the image source is a still image, the color priority mode is set in order to give greater importance to colors, while in the case of a video image, the light amount priority mode is set in order to give greater importance to the light amount. Furthermore, the light amount priority mode is set in a place where the surroundings are bright, and the color priority mode is set in a dark place. Moreover, settings of the light amount priority mode and the color priority mode are not limited to this. Also, a flash memory 54 is provided in the projector control section 51, and stores information for various kinds of settings.

Control information storage sections, such as a RAM (Random Access Memory) 62 and an EEPROM (Electrically Erasable and Programmable Read Only Memory) 63, are connected to the light source control section 61. The EEPROM 63 stores initial values of control data for the light amount priority mode and the color priority mode.

The control data for the light amount priority mode is set based on an current value that is constant in every modulation display period of each color. This control data is set based on the LED driving current in the light amount priority mode shown in E of FIG. 2. The control data in the color priority mode is set based on an current control pattern of the LED in which the light amount is made constant within each modulation display period. This control data is set based on the LED driving current in the color priority mode shown in F of FIG. 2.

In FIG. 3, the control data is transmitted from the EEPROM 63 to the RAM 62 at the time of initialization after turning on the power supply, or where necessary as a result of user operation, and LED control is performed based on the control data transmitted to the RAM 62.

The light source control section 61 is configured with a CPU, a gate array, or a combination thereof and so forth, and reads the control data on the RAM 62 by the timing signal from the DMD drive control circuit 2 and the clock signal from a clock generator not shown in the diagram, and generates the LED driving current by means of a D/A conversion circuit 64 and an current control circuit 65. In the light amount priority mode, the control data of constant current is read, and the LED driving current becomes constant. In the color priority mode, control data that allows the light amount to be constant is read in sequence, and the LED driving current changes sequentially to make the light amount constant.

At the same time, the light source control section 61 gives a switching circuit 66 a switching control signal in synchronization with modulation display period of each color. The switching circuit 66 is switched by this switching control, and distributes the driving current to each of the RGB LEDs 5r, 5g, and 5b.

In the case where the irradiated light amount is feedback, the light amount detection signal from the light amount sensor 17 is sent to a gain switch 67. The gain switch 67 switches the gain, in synchronization with a lighting color of the LED to make a signal within a substantially constant range. The light amount detection signal with a constant range through the gain switch 67 is converted into a digital signal by an A/D conversion circuit 68, and is sent to the light source control section 61.

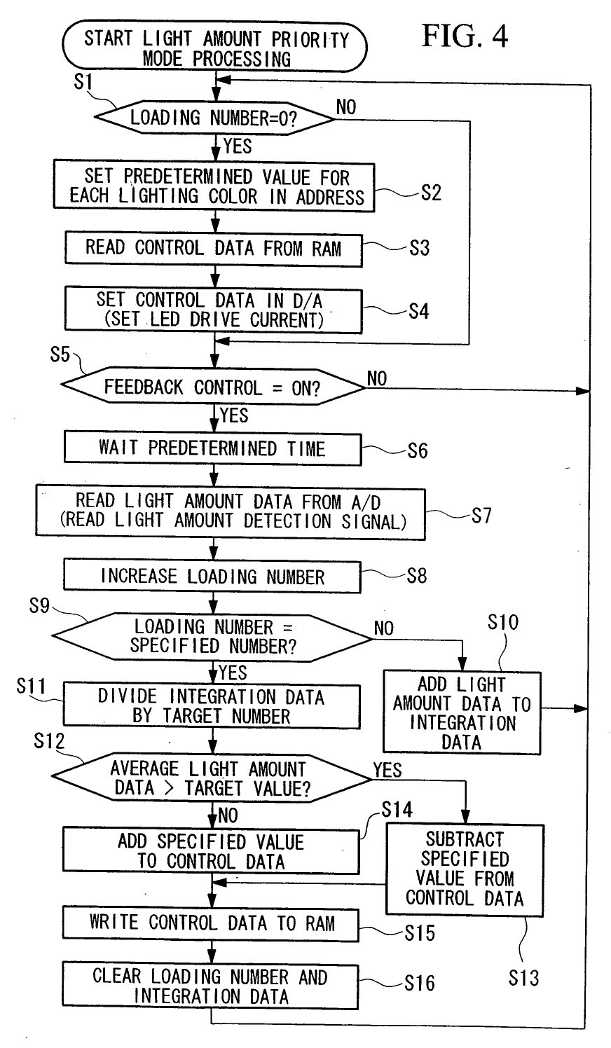

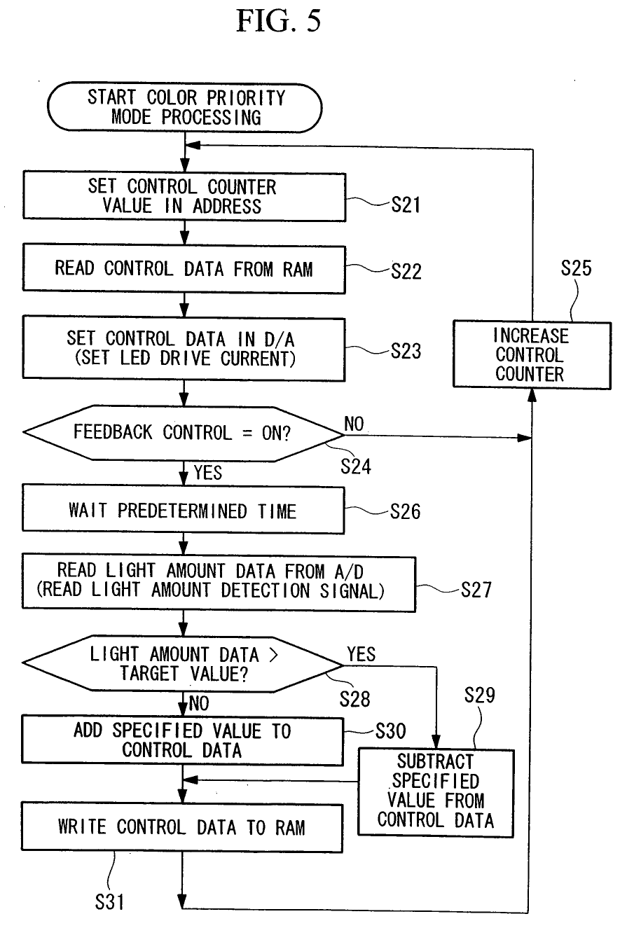

FIG. 4 and FIG. 5 are flow charts that show operations of the LED drive control circuit 3, FIG. 4 showing processing in the light amount priority mode, and FIG. 5 showing processing in the color priority mode.

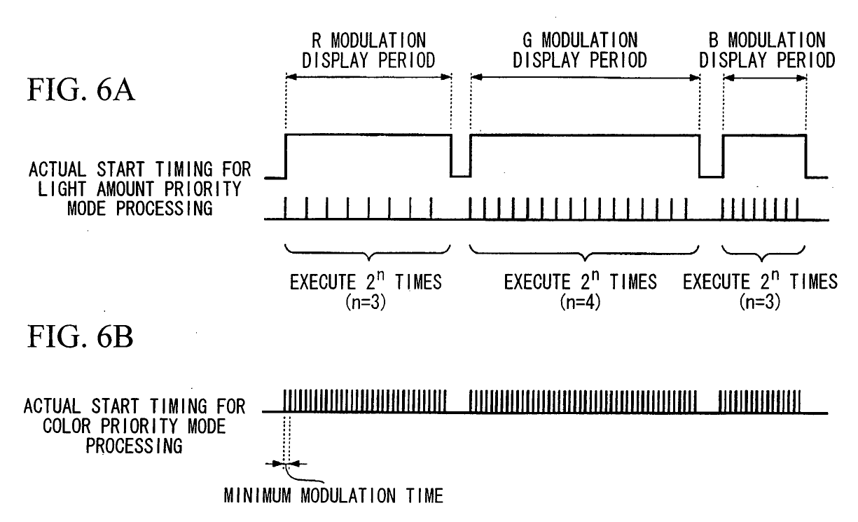

First, control in the case of the light amount priority mode is described. In the light amount priority mode, a series of processing from step S1 to S16 in FIG. 4 is performed 2 to the power of n times (where n is a positive integer) within each display period as shown in FIG. 6A. Then in the case where feedback control is performed, a specified number of light amount detection data loadings is set to 2 to the power of n times, and the light amount detection data is loaded 2 to the power of n times within the modulation display period of each color, and control data update is performed using an average value of this light amount detection data loaded 2 to the power of n times. Here the specified loading number is 2 to the power of n because the processing for finding the average value can be realized by bit shifting, but naturally the predetermined value of the loading number is not limited to 2 to the power of n.

In FIG. 4, it is determined whether or not the light amount detection data loading number is “0” (step S1). If the loading number is “0”, then a predetermined address for each color is set in an address bus by the light amount control section 61 (step S2). The predetermined address of each color on the RAM 62 stores control data of a constant current for each color as shown in E of FIG. 2, and the control data is read from the RAM 62 (step S3). Then this control data is set in the D/A conversion circuit 64 and an LED driving current is set (step S4). Subsequently it is determined whether or not the feedback control is ON (step S5). If the feedback control is not ON, the LED is turned on by this LED driving current, and the processing returns to the start. As a result, a constant driving current is continuously applied to the LED.

In step S5, when the feedback control is ON, then after waiting for a predetermined time until the output of the light amount sensor 17 has stabilized (step S6), the light amount data is read from the A/D conversion circuit 68 (step S7). Then the loading number is increased (step S8), and it is determined whether or not the loading number has reached a specified number (step S9). If the loading number has not reached the specified number, the loaded light amount data is added to the light amount integration data (step S10), and then the processing returns to the start.

By repeatedly performing steps S1 to S10, the light amount of the LED within the modulation display period of each color is integrated. When the loading number has reached the specified number in step S9, the light amount integration data up to this point is divided by a target number in order to find an average light amount data (step S11). When the loading number is set to 2 to the power of n, the division can be achieved by bit shifting.

Subsequently, it is determined whether or not the average light amount data is greater than the target value (step S12). If the average light amount data is greater than the target value, a specified value is subtracted from the control data (step S13), and if the average light amount data is smaller than the target value, a specified value is added to the control data (step S14). The value found is then written on the RAM 62 as a new control data to perform control data update (step S15). Then the loading number and the average light amount data are cleared (step S16), and the processing returns to the start.

Accordingly, in the light amount priority mode, the LED is driven by constant current. Moreover, in the case of performing the feedback control, the control data is updated so that the average light amount data within the modulation display period of each color becomes equal to the target data. As a result, the driving current of the LED of each color in the next image display period is varied.

Next, control in the case of the color priority mode is described. In the color priority mode, a series of processing from step S21 to S31 is performed for every minimum modulation time as shown in FIG. 6B. Then in the case where feedback control is performed, the light amount detection data is loaded in the minimum modulation time, and the control data update is performed for every minimum modulation time. The minimum modulation time refers to a minimum unit of time for displaying an image when gradation is expressed by PWM driving.

In FIG. 5, a control counter value is set in an address (step S21). In the color priority mode, as shown in F of FIG. 2, a driving current pattern that makes the light amount to be constant for each minimum modulation time is stored in order of the address of the pattern. The control counter generates addresses for sequentially reading control data of such a driving current pattern.

When the control counter value has been set to the address, the control data is read from the RAM 62 (step S22). Then this control data is set in the D/A conversion circuit 64, and LED driving current is set (step S23). Subsequently it is determined whether or not the feedback control is ON (step S24). If the feedback control is not ON, the LED is turned on by this LED driving current, and the control counter is increased (step S25), and the processing returns to the start.

Thereafter, by repeatedly performing steps S21 to S25, control data of the driving current pattern that makes the light amount to be constant is read from the RAM 62 every minimum modulation time, and the LED driving current is set to make the light amount to be constant.

In step S24, when the feedback control is ON, then after waiting for a predetermined time until the output of the light amount sensor 17 has stabilized (step S26), the light amount data is read from the A/D conversion circuit 68 (step S27). Subsequently, it is determined whether or not the average light amount data is greater than the target value (step S28). If the average light amount data is greater than the target value, a specified value is subtracted from the control data (step S29), and if the average light amount data is smaller than the target value, a specified value is added to the control data (step S30). The value found is then written on the RAM 62 as a new control data to perform control data update (step S31). As a result, the control data is updated every minimum modulation time. Consequently, the driving current of the LED of each color in the next image display period is varied.

It may be made such that a user can set control periods in the light amount priority mode and/or the color priority mode using external signals by which the input signals for setting the control periods in the light amount priority mode and/or the color priority mode are given to the LED drive control circuit 3.

Moreover, control periods in the light amount-priority mode and/or the color priority mode may be set according to the type of the image.

Furthermore, in the examples of FIG. 4 and FIG. 5, the feedback control can be set to either ON or OFF. When the feedback control is turned on, in the light amount priority mode the characteristics of the LED due to changes over time can be compensated. In the color priority mode, the characteristics of the LED due to changes over time can be compensated while the light amount can be maintained constant at a high level of accuracy. However, when the feedback control is turned on, power consumption increases due to an increase in writing to the RAM 62 and data processing. Also, in order to turn on the feedback control, the light amount sensor 17 or the like is required.

Therefore, in usual use, it may be considered that the feedback control is turned on, and the feedback control is turned off when reducing power consumption. Moreover, in an inexpensive model may be considered, in which the light amount sensor 17 is not provided, and the feedback control is always turned off. Furthermore, the turning on and off of the feedback control is appropriately set according to the user setting or environment.

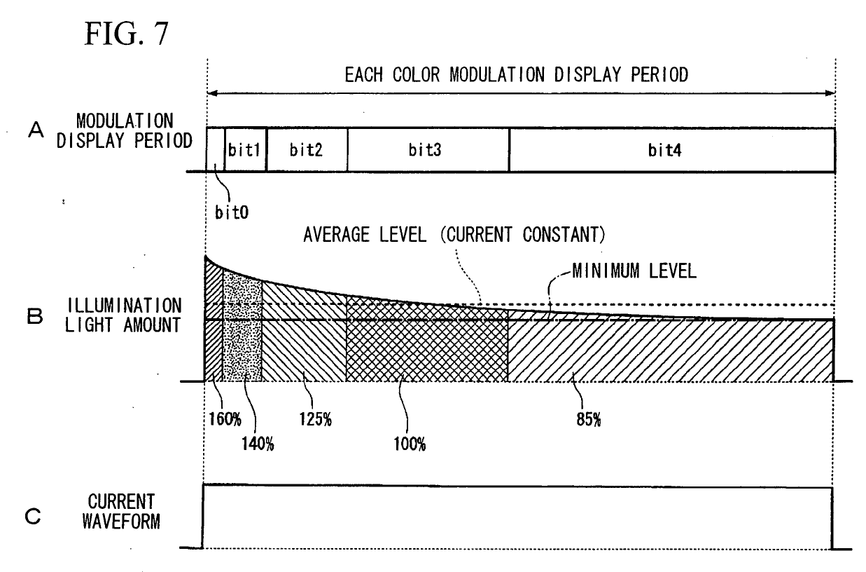

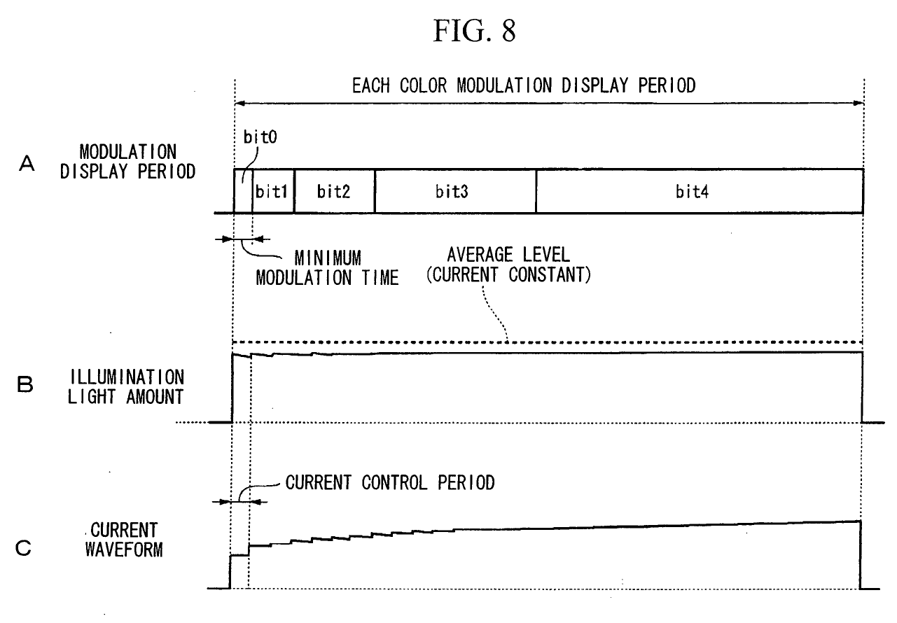

FIG. 7 shows a relationship between a gradation display period and an illumination light amount in the light amount priority mode, and FIG. 8 shows a relationship between the gradation display period and illumination light amount in the color priority mode.

When expressing the input image signal in 5 bit gradation for example, then as shown in A of FIG. 7 and A of FIG. 8, the display period is divided into pulses of five types having a time ratio of 1:2:4:8:16 with respect to each bit (bit 0, bit 1, bit 2, bit 3, bit 4), and by a combination of these pulses, the illumination light is reflected in the direction of the projection optical system by the minute mirrors on the DMD element 4 only during periods where the pulse is ON. Here, a duration that corresponds to the least significant bit “bit 0” is the minimum modulation time.

For example, where the input image data is “01111”, in A of FIG. 7, bit 0 is ON, bit 1 is ON, bit 2 is ON, bit 3 is ON, bit 4 is OFF, and the integrated value of the LED light emission within the duration from bit 0 to bit 3 is the modulated light amount. Where the input image data is “10000”, in A of FIG. 7, bit 0 is OFF, bit 1 is OFF, bit 2 is OFF, bit 3 is OFF, and bit 4 is ON, and the integrated value of the LED light emission within the duration of bit 4 is the modulated light amount.

In the light amount priority mode, as shown in C of FIG. 7, the LED is driven by a constant driving current. In this case, due to influence of heat generation of the LED, the illumination light amount from the LED changes during the modulation display period of each color so as to decrease as time passes as shown in B of FIG. 7. In B of FIG. 7 and B of FIG. 8, dotted lines denote an average level in the light amount priority mode, and alternate long and short dash lines denote a minimum level.

Conversely, in the color priority mode, as shown in C of FIG. 8, the LED is driven by a driving current that makes the light amount to be constant. That is to say, as shown in C of FIG. 8, the driving current of the LED rises as time passes, compensating the reduction in the illumination light amount of the LED. As a result, as shown in B of FIG. 8, the illumination light amount from the LED becomes constant within the modulation display period of each color. As shown in B of FIG. 8, the light amount of the LED in the color priority mode is below the average level.

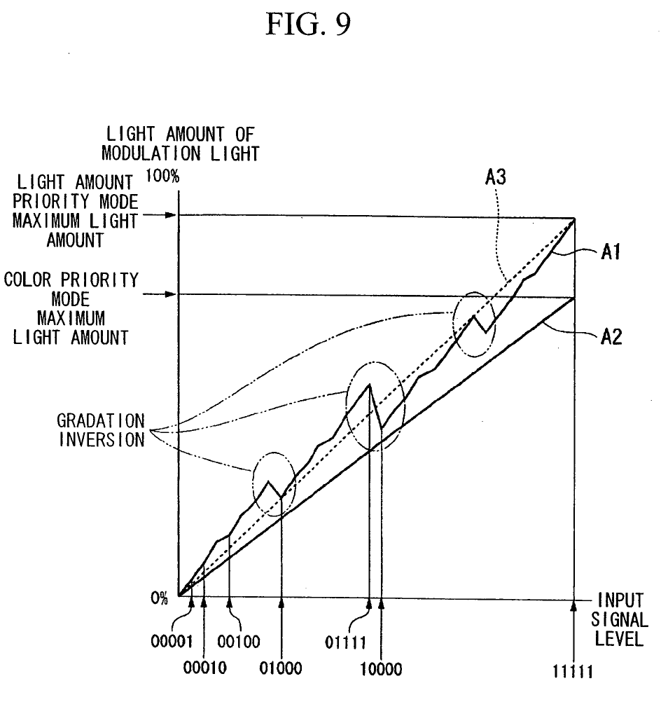

FIG. 9 shows gradation characteristics of the modulation light in each mode. In FIG. 9, the horizontal axis denotes the input signal level (5 bit) and the vertical axis denotes the light amount of the modulation light. A1 shows the gradation characteristics of the modulation light in the light amount priority mode, and A2 shows the gradation characteristics of the modulation light in the color priority mode. The light amount of the modulation light is shown taking the maximum light amount of the light amount priority mode as 100 per cent. Moreover, A3 shows ideal linear characteristics in the light amount priority mode.

As shown by the characteristics A1 in FIG. 9, in the light amount priority mode, the overall light amount becomes higher. However, the relationship between the input signal level and light amount is not linear and gradation inversion occurs.

On the other hand, in the color priority mode, the light amount is constant. As a result, as shown by the characteristics A2 in FIG. 9, the relationship between the input signal level and the light amount is linear and gradation inversion does not occur. However, in the case of the color priority mode, the light amount is smaller than the characteristics A1 in the light amount priority mode with respect to any gradation.

### Second Embodiment

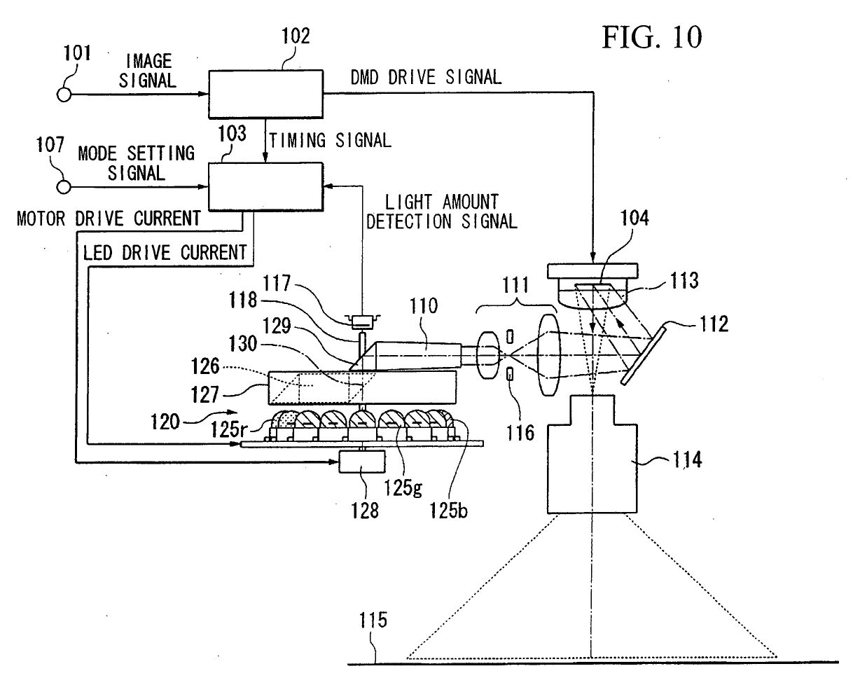

FIG. 10 shows a second embodiment of a projector to which the present invention is applied. In this example, a plurality of the LEDs are arranged in a circle, and a rotation optical system that switches the LEDs with a rotation rod is used.

In FIG. 10, an image signal is supplied to an input terminal 101. The image signal from the input terminal 101 is supplied to a DMD drive control circuit 102. The DMD drive control circuit 102 converts the input image signal into an RGB field sequential DMD driving signal, and outputs this RGB field sequential DMD driving signal to a DMD element 104. Moreover, a timing signal that synchronizes with the field sequential driving signal is generated in the DMD drive control circuit 102. This timing signal is supplied to the light source drive control circuit 103.

The DMD element 104 is a spatial light modulation element that has a large number of minute mirrors disposed on the surface thereof, the angles of the mirrors being changeable with respect to each pixel. When the DMD driving signal from the DMD drive control circuit 102 is given to the DMD element 104, the angles of the minute mirrors on the surface of the DMD element 104 change, consequently changing the path of the light to perform ON/OFF of the light for each pixel.

The light source drive control circuit 103 generates a driving current for each of the RGB colors according to a modulation display period of each color based on the timing signal from the DMD drive control circuit 102. A mode setting signal from an input terminal 107 is supplied to the light source drive control circuit 103. The mode setting signal is a signal for switching between the light amount priority mode and the color priority mode. The light source drive control circuit 103 sets the LED driving current to be constant in the light amount priority mode. In the color priority mode, the LED driving current is varied within each modulation display period so that the light amount is constant. Moreover, the light source drive control circuit 103 generates a motor drive signal based on the timing signal from the DMD drive control circuit 102.

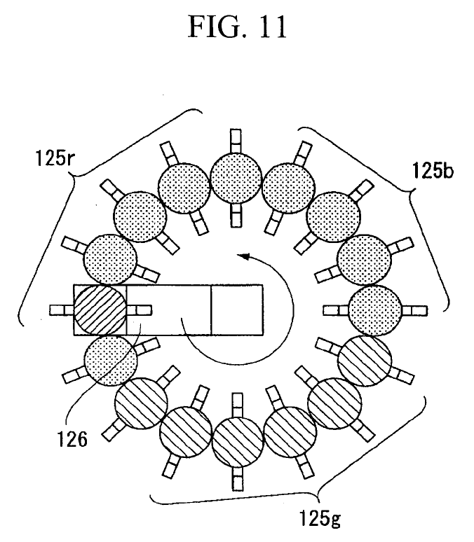

As shown in FIG. 11, in a rotation optical system 120, a plurality of red color LEDs 125r, a plurality of green color LEDs 125g, and a plurality of blue color LEDs 125b are arranged in a circle opposite to the locus of an input end of a rotating rod 126 which rotates. The rotation rod 126 is attached to the rotation holder 127 and rotates with the rotation of a motor 128. When the rotation rod 126 rotates, the LED that is in the position corresponding to the rotation rod 126 among the plurality of the LEDs 125r, 125g, and 125b arranged in a circle lights, and the light is guided through the rotation rod 126 and is taken out from the light output surface in the rotation center.

The light from the rotation rod 126 is incident on a tapered rod 110 via a reflecting prism 129. The tapered rod 110 removes unevenness in the light amount in a sectional direction. The light outputted from the output end of the tapered rod 110 travels through an illumination optical system comprising an illumination lens 111, an illumination aperture 116, a mirror 112, and a field lens 113, and is then irradiated onto the surface of the DMD element 104 on which the minute mirrors are formed.

The angles of the minute mirrors on the surface of the DMD element 104 are changed by the DMD driving signal, thereby changing the path of the light. Therefore, the reflected light of the DMD element 104 is modulated for each pixel by the DMD driving signal. The light modulated by this DMD driving signal is magnified as projection light through a projection lens 114, and is projected onto a projection surface 115. As a result, an image made up of a plurality of pixels which are two dimensionally arranged in a matrix, is projected onto the projection surface 115.

A light amount sensor 117 is provided on an extension of the rotation axis of the rotation rod 126. The light output from the rotation rod 126 traveling through the light collection rod 118 is detected by the light amount sensor 117. A light detection signal from the light amount sensor 117 is transmitted to the light source drive control circuit 103.

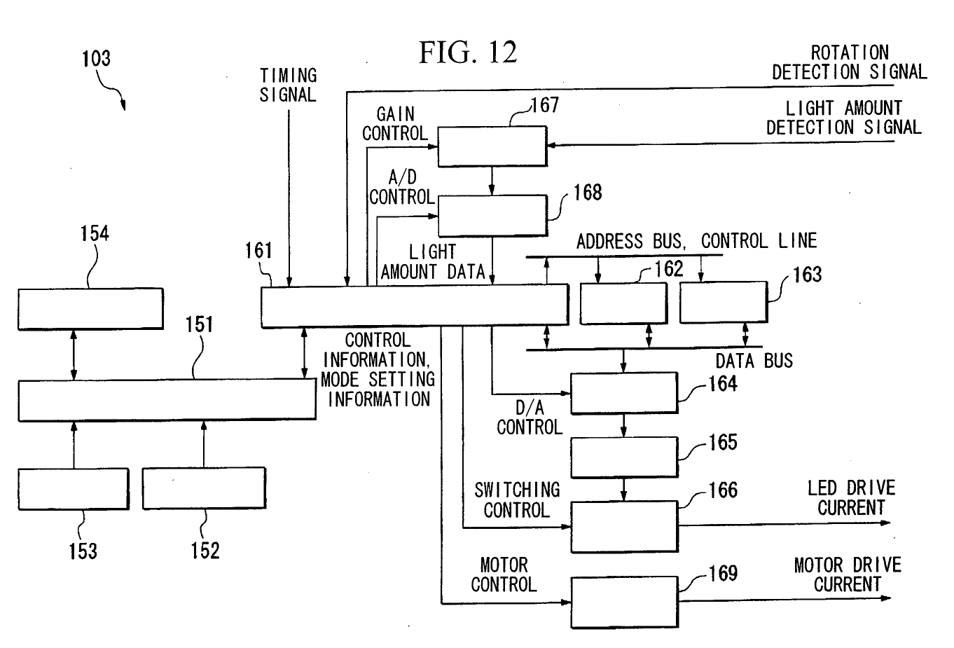

FIG. 12 shows a specific configuration example of the light source drive control circuit 103. In FIG. 12, a projector control section 151 is configured mainly with a CPU that controls the overall projector. The projector control section 151 is connected to a light source control section 161.

The projector control section 151 receives signals from an input signal discriminator 152 that discriminates the type and presence of the input image, and from a user I/F section 153 such as an operation panel or remote controller for a user to perform various kinds of settings, and outputs control information and mode setting information to the light source control section 161. Moreover, a flash memory 154 is provided in the projector control section 151.

A RAM 162 and EEPROM 163 are provided for the light source control section 161. The EEPROM 163 stores control data that corresponds to the setting value of the LED driving current as an initial value. The control data are control data in the light amount priority mode and control data in the color priority mode.

The control data is transmitted from the EEPROM 163 to the RAM 162 at the time of initialization after turning on the power supply, or where necessary as a result of user operation, and LED control is performed based on the control data transmitted to the RAM 162.

The light source control section 161 is configured with a CPU, a gate array, or a combination thereof and so forth, and reads the control data on the RAM 162 by the timing signal from the DMD drive control circuit 102 and the clock signal from a clock generator not shown in the diagram, and generates the driving current by means of a D/A conversion circuit 164 and an current control circuit 165. At the same time, a switching circuit 166 distributes the driving current as a driving current to the LEDs 125r, 125g, 125b of the respective colors according to the switching control from the light source control section 161. Moreover, the light source control section 161 generates a motor drive signal based on a synchronization signal and timing signal, and supplies this motor drive signal to the motor 128 via a motor driver 169.

In the case where the irradiated light amount is fedback, the light amount detection signal from the light amount sensor 117 is sent to a gain switch 167. The gain switch 167 switches the gain, in synchronization with a lighting color of the LED to make a signal within a substantially constant range. The light amount detection signal with a constant range through the gain switch 167 is converted into a digital signal by an A/D conversion circuit 168, and is sent to the light source control section 161.

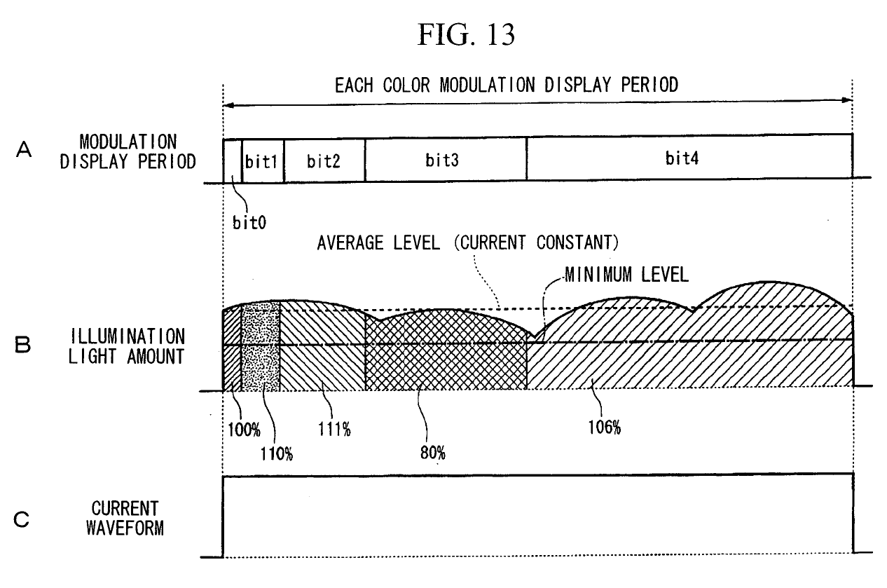

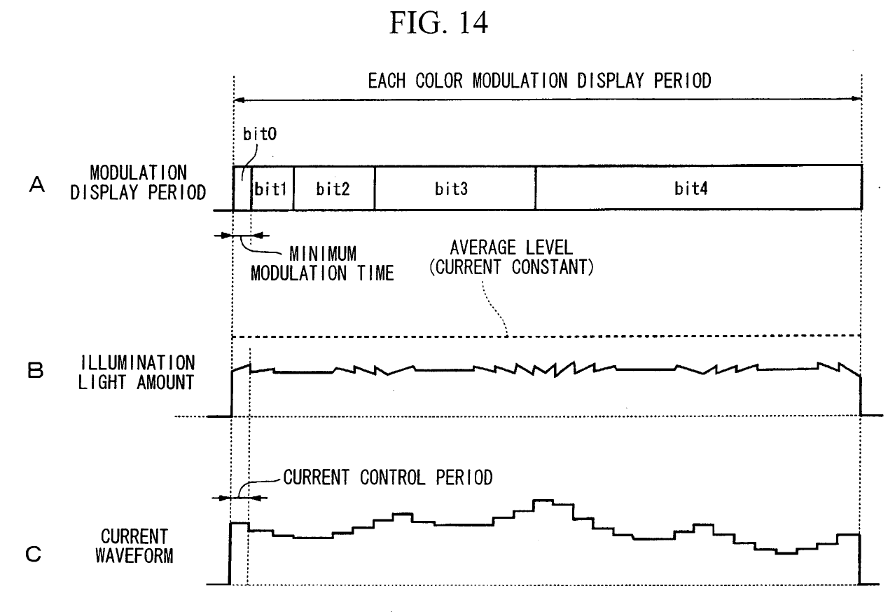

FIG. 13 shows a relationship between a gradation display period and an illumination light amount in the light amount priority mode, and FIG. 14 shows a relationship between the gradation display period and illumination light amount in the color priority mode. When expressing the input image in 5 bit gradation for example, then as shown in A of FIG. 13 and A of FIG. 14, the display period is divided into pulses of five types having a time ratio of 1:2:4:8:16, with respect to each bit (bit 0, bit 1, bit 2, bit 3, bit 4), and the illumination light is reflected in the direction of the projection optical system by the minute mirrors on the DMD element 104 only during periods where the pulse is ON with a combination of these pulses.

In the light amount priority mode, the LED is driven by a constant driving current as shown in C of FIG. 13. In this case, as shown in B of FIG. 13, the illumination light amount from the LED changes. In the case where the rotation optical system 120 is used, variation in the illumination light amount includes variation in the light amount due to temperature variation as well as variation in the illumination light amount due to switching of the LEDs by rotation of the rotation rod 126.

Conversely, in the color priority mode, as shown in C of FIG. 14, a driving current that compensates the light amount variation due to temperature changes or rotation of the rotation rod 126 and that makes the light amount to be constant is supplied to the LED. As a result, as shown in B of FIG. 14, the illumination light amount from the LED becomes constant.

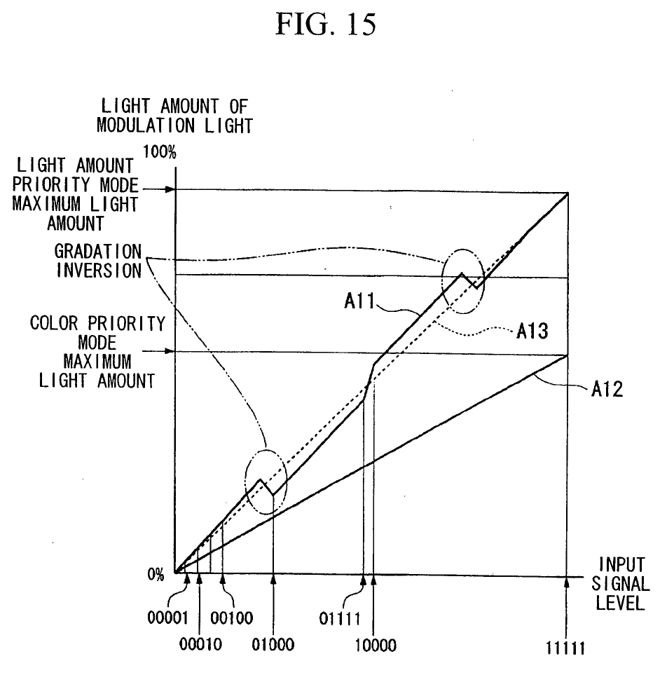

FIG. 15 shows gradation characteristics of the modulation light in each mode. In FIG. 15, the horizontal axis denotes the input signal level (5 bit) and the vertical axis denotes the light amount of the modulation light. All shows the gradation characteristics of the modulation light in the light amount priority mode, and A12 shows the gradation characteristics of the modulation light in the color priority mode. The light amount of the modulation light is shown taking the maximum light amount of the light amount priority mode as 100 per cent. Moreover, A13 shows ideal linear characteristics in the light amount priority mode.

As shown by the characteristics A11 in FIG. 15, in the light amount priority mode, the overall light amount becomes higher. However, the relationship between the input signal level and light amount is not linear and gradation inversion occurs.

On the other hand, in the color priority mode, the light amount is constant. As a result, as shown by the characteristics A12 in FIG. 15, the relationship between the input signal level and the light amount is linear and gradation inversion does not occur. However, in the color priority mode, the light amount is smaller than the characteristics A11 in the light amount priority mode with respect to any gradation.

Furthermore, in the case where feedback control is performed using such a rotation optical system, it is necessary that the light amount detection signal from the light amount sensor 117 not be affected by rotation of the rotation rod 126. Therefore, in this example, the light collection rod 118 is positioned coaxially with the rotation axis 130 of the rotation rod 126, so that the light from the light collection rod 118 is guided to the light amount sensor 117 on the extended axis of the rotation axis 130.

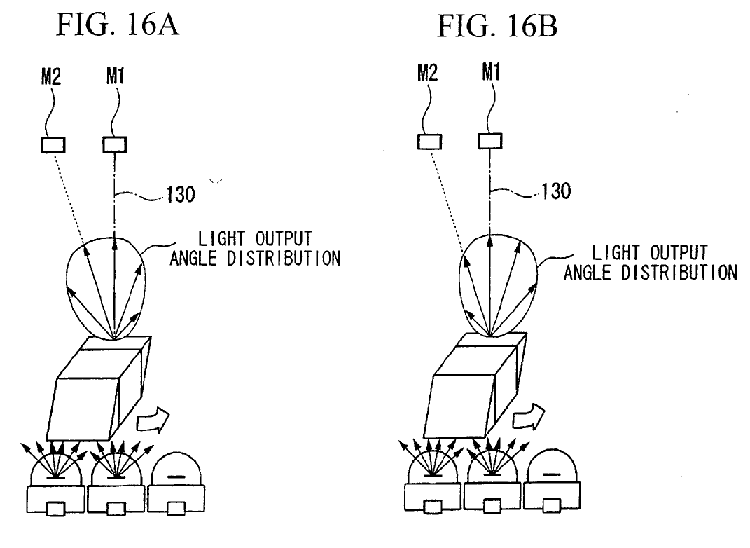

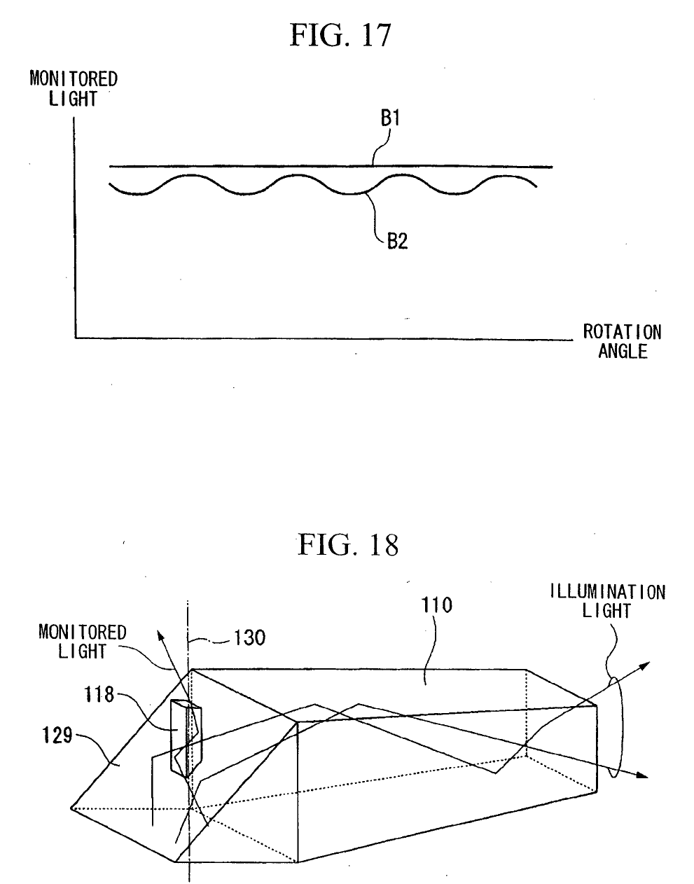

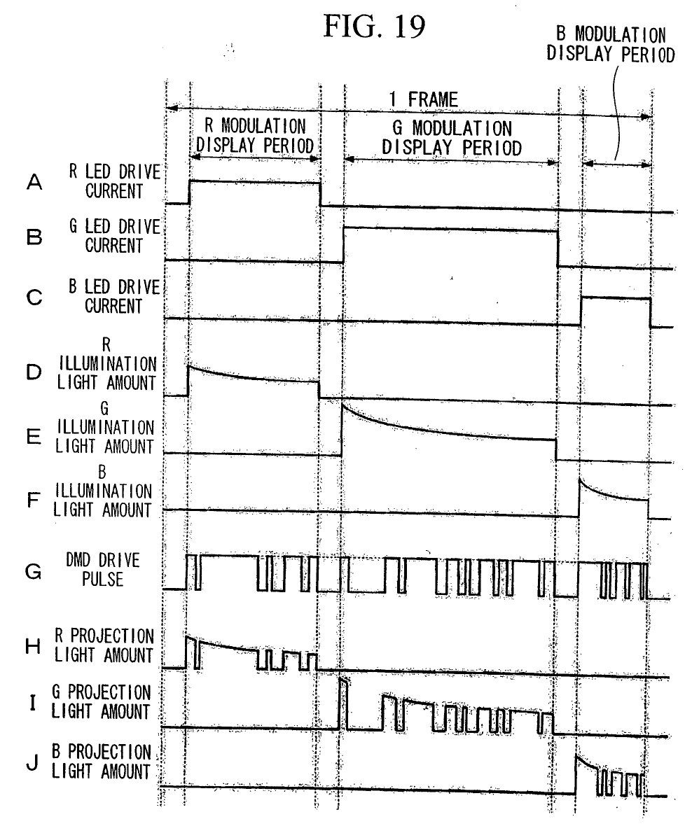

That is to say, as shown in FIG. 16A and 16B, when the relative positions of the LED and the rotation rod change, deviation in the light output angle distribution changes. In FIG. 16A and FIG. 16B, in the case where a light amount monitor M1 is placed on the rotation axis 130 of the rotation rod 126, the monitored light amount is constant with respect to the rotational angle as shown with characteristics B1 in FIG. 17. On the other hand, in FIG. 16A and FIG. 16B, in the case where a light amount monitor M2 is placed in a position displaced from the rotation axis 130, the monitored light amount changes as shown with characteristics B2 in FIG. 17 due to deviation in the light output angle distribution.

Consequently, in this embodiment, as shown in FIG. 18, the light collection rod 118 (this may be a lens) is adhered and attached, coaxially with the rotation axis 130 of the rotation rod 126, on the outside of a reflecting prism of a tapered rod 110 optically behind the rotation rod 126, and the light amount sensor 117 is disposed on the extension of the rotation axis of the rotation rod 126. The reflecting prism 129 has a reflecting surface that reflects the light output from the rotation rod 126, and the reflection characteristics within a minute area around the rotation axis of the reflecting surface is made different from that in the circumference, allowing the light that has passed through this minute area to be guided to the light amount sensor 117 by the light collection rod 118. The light amount sensor 117 may be disposed in a position where the light path has passed through the mirror 112, as long as the position is on the extension of the rotation axis along the light path.

What is claimed is:

1. An image projection apparatus that displays images according to image information that is input, and having a plurality of pixels that can be independently switched between display status and non display status, arrayed in a matrix, comprising:
a spatial light modulation element that modulates illumination light by switching the display and non-display statuses of the respective pixels based on pulse width modulation driving to perform gradation expression for each pixel;
a light source section able to increase and decrease the amount of illumination light output according to an input controlled variable;
a light source control section that periodically controls the light amount of the illumination light output from the light source section; and
a projection optical section that projects images modulated by the spatial light modulation element, wherein
the light source control section selectively controls the light amount of the illumination light output from the light source section by either one of a first mode in which the controlled variable is changed in a first control period that is shorter than the display period for the spatial light modulation element to display the input image information, and a second mode in which the controlled variable is changed in a second control period that is longer than the first control period.

2. An image projection apparatus according to claim 1, wherein the second control period in the second mode is equal to or longer than the display period.

3. An image projection apparatus according to claim 1, wherein the first control period in the first mode is equal to or longer than a minimum duration to put pixels into display status when performing gradation expression using pulse width modulation driving.

4. An image projection apparatus according to claim 1, wherein the light source control section controls the light amount of the illumination light output of the light source section so that a time average value of the illumination light is greater in the second mode than in the first mode.

5. An image projection apparatus according to claim 1, which has a control information storage section that stores light amount control information,
and the light source control section controls the light amount of the illumination light output of the light source section based on control information from the control information storage section, in at least the first mode.

6. An image projection apparatus according to claim 5, which has a light amount detection section that detects the light amount of the illumination light output of the light source section,
and control information stored in the control information storage section can be changed based on a detection result of the light amount detection section.

7. An image projection apparatus according to claim 6, which performs a series of operations within the first control period in the first mode, the series of operations comprising:
obtaining control information from the control information storage section,
controlling the light amount of the illumination light output of the light source section based on the control information,
obtaining the output of the light amount detection section,
changing the control information from the control information storage section based on this output, and
storing the changed control information in the control information storage section again.

8. An image projection apparatus according to claim 6, which performs a series of operations within the second control period in the second mode, the series of operations comprising:
obtaining control information from the control information storage section,
controlling the light amount of the illumination light output of the light source section based on the control information,
obtaining the output of the light amount detection section,
changing the control information from the control information storage section based on this output, and
storing the changed control information in the control information storage section again.

9. An image projection apparatus according to claim 1, comprising a variable section for a user to change the first control period and/or the second control period.

10. An image projection apparatus according to claim 1, wherein the light source control section changes the first control period and/or the second control period according to the type of the image information.

11. An image projection apparatus according to claim 1, configured to allow a user to make a selection between the first mode and the second mode.

12. An image projection apparatus according to claim 6, wherein the light source section comprises:
a plurality of light emitting elements arranged in a circle; and
a rotation optical section that selectively guides light output from the plurality of the light emitting elements to a common light path by rotating around a rotation axis passing through the center of the circle, and the common light path is provided coaxially with the rotation axis,
and the light amount detection section is disposed on an axis that extends along a light path in common with the rotation axis.

13. An image projection apparatus according to claim 12, which has a reflecting surface that reflects the light outputted from the rotation optical section,
and the reflection characteristic of a minute area centered around the rotation axis of the reflecting surface is made different from that of the circumference, and light that passes through the minute area becomes light that is received by the light amount detection section.

14. An image projection apparatus according to claim 13, wherein the reflecting surface is an internal surface of a prism disposed on an optically back side of the rotation optical section,
and the minute area is formed by having a minute optical element adhered to an outside of the reflecting surface, and light that passes through the minute area becomes the light that is received by the light amount detection section.
